(19) United States
(12) Patent Application Publication
(10) Pub. No.: US 2019/0316791 A1
(43) Pub. Date: Oct. 17, 2019

(54) AirMePad

(71) Applicant: Bobby Joe Kennedy, Dothan, AL (US)

(72) Inventor: Bobby Joe Kennedy, Dothan, AL (US)

(21) Appl. No.: 15/951,479

(22) Filed: Apr. 12, 2018

(51) Int. Cl. F24F 7/007; F04D 29/00; F04D 15/00; F04D 25/06; F21V 33/00

(52) U.S. Cl. CPC F24F 7/007; F04D 29/005; F21Y 2115/10; F04D 25/0673; F21V 33/0096; F04D 15/0066

(57) ABSTRACT

The AirMePad small design makes it easy and affordable to provide quick and easy air to the face or air to push particles away from the eyes and nose to help improve breathing cleaner air. It also provides simple and quick LED lighting to help reading at night or in dark places or moving around just by the touch of your fingers. It can be used under the hat, on an automobile visor, computer monitor, and many other places to help people easily cool off and push air particles away.

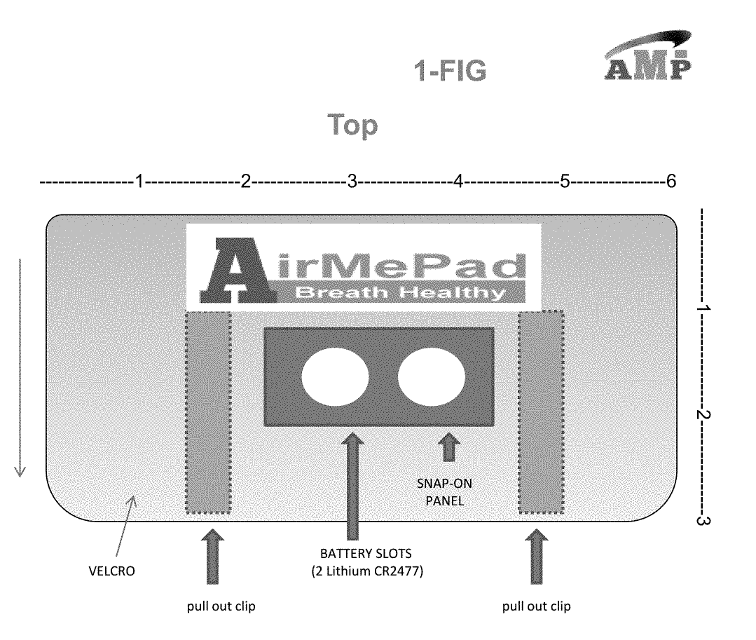

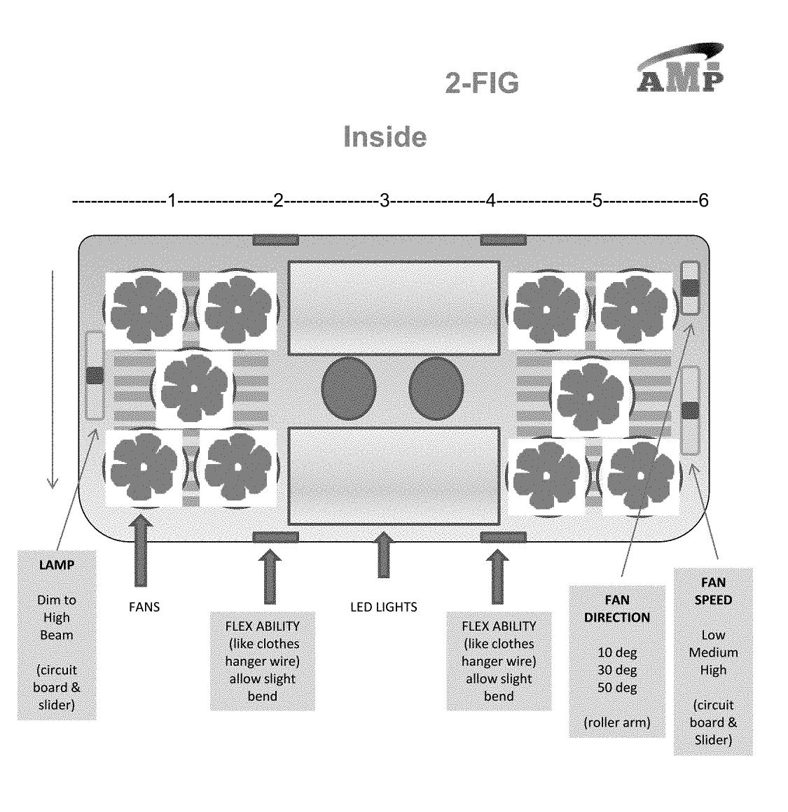

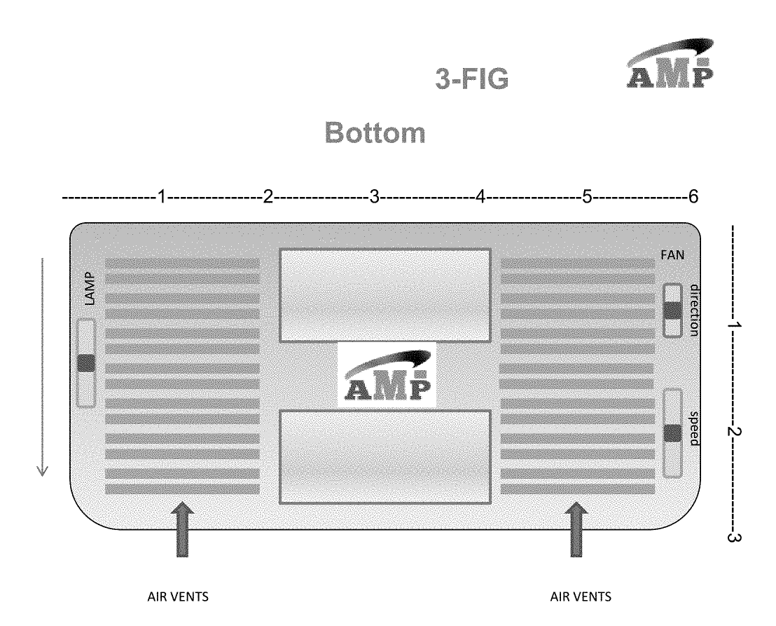

### BACKGROUND OF THE INVENTION

AirMePad is created to provide air to the face or air to push partials away from the face to allow fresh breathing. It also has the capability to provide LED lighting to make it easy to read or move around in dark places.

### BRIEF SUMMARY OF THE INVENTION

AirMePad is designed to provide air to the face or air to push partials away from the eyes and nose to help improve clean air intake to the body. Also it provides quick LED lighting to help reading at night or in dark places or moving around in dark places.

### BRIEF DESCRIPTION OF THE SEVERAL VIEWS OF THE DRAWING

1-FIG. TOP
Fits under the bill/visor of the hat and is used to secure the pad. Batteries are inserted in slots under snap-on panel.

2-FIG. INSIDE
The mini-fans, led lights, and wiring.

3-FIG. BOTTOM
Where the air flows out and provides lightning.

### DETAILED DESCRIPTION OF THE INVENTION

AirMePad is created to provide air to the face or air to push particles away from the face to allow fresh breathing. By providing this capability it not only provides fresh air but also could improve the health of those who have allergies or weak immune systems. By providing this easy air pad it could help improve someone's health and possibly give them the ability to reduce drug intake they may be taking. It also provides easy LED lighting for reading for moving around.

It can be used under the hat, on an automobile visor, computer monitor, and many other places to help people easily cool off and push air particles away.

1. AirMePad is unique in the fact it can provide quick and easy air to the face or air to push particles away from the eyes and nose to help improve cleaner air intake to the body. This unique design and easy availability could also help people with allergies, weak immune systems, breathing disorders, and other health issues to provide a “Breath Healthy” life style. It can also provide LED lighting to help reading at night or in dark places or moving around.
It can be used under the hat, on an automobile visor, computer monitor, and many other places to help people easily cool off and push air particles away.
